(19) United States
(12) Patent Application Publication
(10) Pub. No.: US 2023/0276912 A1
(43) Pub. Date: Sep. 7, 2023

(54) Merchandising Ornament

(71) Applicant: Diane Sherwood, Wichita, KS (US)

(72) Inventor: Diane Sherwood, Wichita, KS (US)

(21) Appl. No.: 17/684,822

(22) Filed: Mar. 2, 2022

(51) Int. Cl. A44C 15/00; B42D 15/02; B42D 25/40; B42D 25/305; A44C 17/00; A44C 27/00

(52) U.S. Cl. CPC A44C 15/003; B42D 15/027; B42D 25/40; B42D 25/305; A44C 17/008; A44C 27/00

(57) ABSTRACT

The present disclosure provides a merchandising ornament. The merchandising ornament includes a stone at least semitransparent, a near-field communication (NFC) chip, an upper decal, and a lower covering. NFC chip is coupled to the stone and configured to store touchpoint information to transfer to a receiving device. The stone includes a generally planar base. The upper decal has a top face and a bottom face with the top face bearing a design and being adhered to at least a portion of the planar base of the stone. The design on the front face is visible through the stone. The lower covering has a top face and a bottom face with the top face of the lower covering being adhered to the bottom face of the upper decal such that the near-field communication chip is secured and concealed between the upper decal and the lower covering.

### FIELD

The present disclosure generally relates to a merchandising ornament, and more particularly, to a merchandising ornament having touchpoint information and decal.

### BACKGROUND

Traditionally, paper business cards have been used for transferring merchandising information; however, paper business cards can be easily damaged or lost prior to transferring to a receiving party or after being given to the receiving party. Depending on the intensity of the damage or if the card is lost, the receiving party may not retain the information provided on the card.

More recently, contactless methods for transferring merchandising information have been used. One method includes messaging the merchandising information to the receiving party; however, this method requires obtaining personal information from the receiving party such as a phone number. QR codes have been widely used for wirelessly transferring merchandising information to avoid obtaining personal information from the receiving party; however, these require the receiving party to utilize a camera to scan the QR code and require displaying the QR code on marketing materials, which may negatively affect the marketing for the business.

### BRIEF DESCRIPTION OF THE DRAWINGS

FIG. 1 is a top perspective photograph of the merchandising ornament of the present disclosure;

FIG. 2 is a bottom perspective photograph of the merchandising ornament;

FIG. 3 is a side perspective photograph of the merchandising ornament;

FIG. 4 is an exploded perspective of the merchandising ornament; and

FIG. 5 is a schematic of a method for making the merchandising ornament.

Corresponding reference characters indicate corresponding parts throughout the drawings.

### DETAILED DESCRIPTION

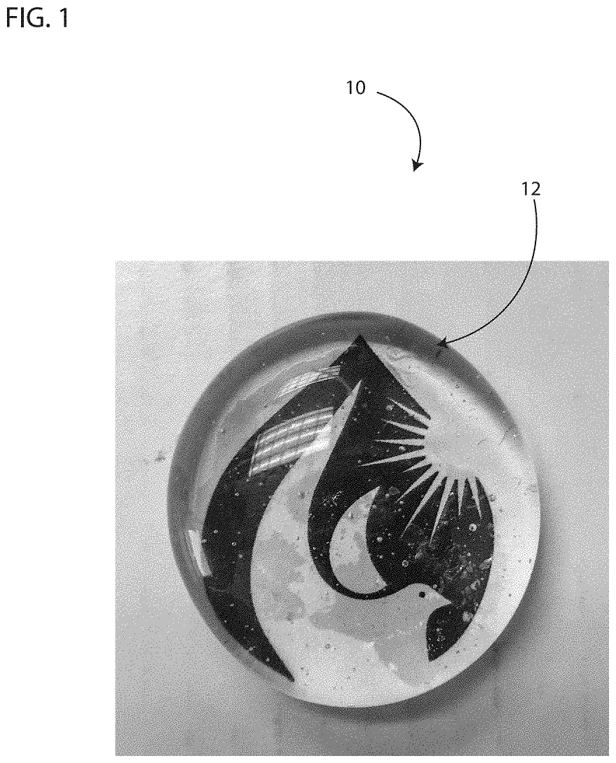

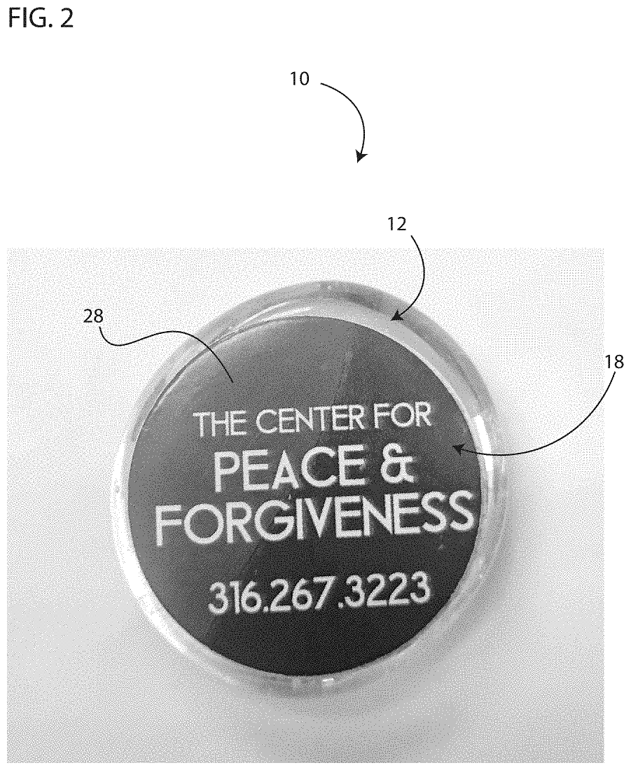

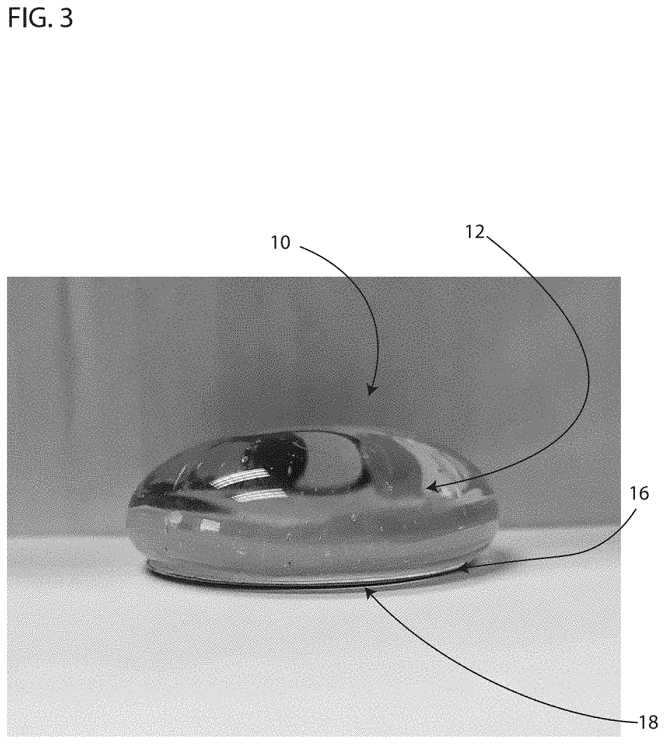

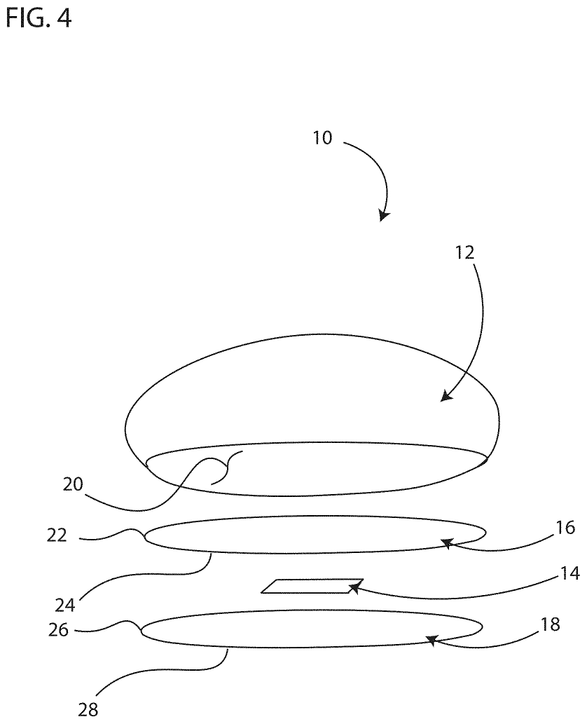

Referring to FIGS. 1-3, an exemplary embodiment of a merchandising ornament is generally indicated at reference number 10. As explained more fully below, the merchandising ornament 10 is configured to provide an ornamental reminder of a particular enterprise or person and also to digitally transfer additional information to a receiving party. As shown in FIGS. 1-3, the ornament 10 includes a stone, generally indicated at reference numeral 12, of a semitransparent material. The ornament 10 further includes a near-field communication (NFC) chip 14 (FIG. 4), an upper decal 16 (FIGS. 1, 3, and 4), and a lower covering 18 (FIGS. 2, 3, and 4).

As shown in FIGS. 1-4, the stone 12 (e.g., Hobby Lobby's Clear Oval Glass Gems/Stones) has a generally planar base 20 that is configured to couple the upper decal 16, the NFC chip 14, and the lower covering 18. In an embodiment, the upper decal 16, lower covering 18, and the planar base 20 all have substantially same size and general shape. In an alternative embodiment, the upper decal 16 and lower covering 18 may be the same general shape as the planar base 20 with a smaller cross sectional area. In a non-limiting example, the planar base 20 may generally be a diameter of 1.25 inches while the upper decal 16 and lower covering 18 have a diameter of 1 inch.

As shown in FIG. 1, the upper decal 16 has a top face 22 adhered to at least a portion of the planar base 20 of the stone 12 and a bottom face 24 adhered to the lower covering 18. As shown, the top face 22 of the upper decal includes a design that is visible through the semitransparent material of the stone 12. In an embodiment, the stone 12 is generally domed-shaped magnifying the design of the upper decal 16 through the semitransparent material of the stone. The top face 22 of the upper decal can be secured to the planar base 20 of the stone 12 by any means that would allow the design to be visible through the semitransparent material of the stone. For example, but without limitation, the top face 22 of the upper decal 16 can be secured to the stone 12 by adhesion of top face of the upper decal and the planar base 20 by glue (e.g., Elmer's Clear Glue). In an embodiment, material of the upper decal 16 may be paper, or any other suitable material that allows for the design of the upper decal to visible through the semitransparent material of the stone 12 while maintain adhesion to the planar base 20 of the stone.

The NFC chip 14 is coupled to the stone by the upper decal 16 and the lower covering 18, as can be understood from the exploded view of the ornament 10 in FIG. 4. The NFC chip 14 is positioned between the upper decal 16 and the lower covering 18 to secure the NFC chip to the stone 12 such that the NFC chip will have minimal exposure to damage. The NFC chip 14 stores touchpoint information enabling the ornament 10 to transfer the touchpoint information to a receiving device without contact when the receiving device is within a receiving range. The receiving range is based off a proximity-based wireless communication standard. In an embodiment, the touchpoint information is marketing information for a business, for example, a website url and social medial url. In an embodiment, during transferring the touchpoint information, the receiving device generates a magnetic field by passing an electric current through a coil. The NFC chip 14 with its own coil is brought within the receiving range, and the magnetic field of the receiving device induces an electric current within the coil of the NFC chip such that any stored data on the NFC chip (e.g., website url and social medial url for the business) is wirelessly transmitted to the receiving device.

As shown in FIGS. 2 and 4, the lower covering 18 has a top face 26 and a bottom face 28, the top face of the lower covering being adhered to the bottom face 24 of the upper decal 16 such that the NFC chip 14 is secured and concealed between the upper decal and the lower covering. In an embodiment, as shown in FIG. 2, the lower covering 18 is a lower decal with the bottom face 28 of the lower decal bearing a design. As shown in FIGS. 1-2, the design on the bottom face 28 of the lower decal 18 may be different than the design on the top face 22 of the upper decal 16. In an embodiment, designs of the top face 22 of the upper decal 16 and the bottom face 28 of the lower decal 18 are associated with the business (e.g., logo, business name, contact, etc.). In an embodiment, material of the lower decal 18 may be paper or any other suitable material that provides protection to the NFC chip 14 and allows for proximity-based wireless communication between the NFC chip and the receiving device.

By securing the NFC chip 14 between the upper decal 16 and the lower decal 18, the NFC chip is secured in a concealed fashion, yet there is virtually no change to the size and shape of the stone 12. The merchandising ornament 10 thus combines an aesthetically pleasing graphical display and quick access to augmented touchpoint information in a small form factor that can be used as a handout in virtually any in-person setting. Further, because the decals 16, 18 and chip 14 are substantially flat against the planar base 20, the ornament 10 can sit stably on a flat surface. So when a recipient sets the ornament 10 down on the flat surface, the stone 14 magnifies the ornamental design of the upper decal 18 providing a noticeable and memorable reminder of the information presented.

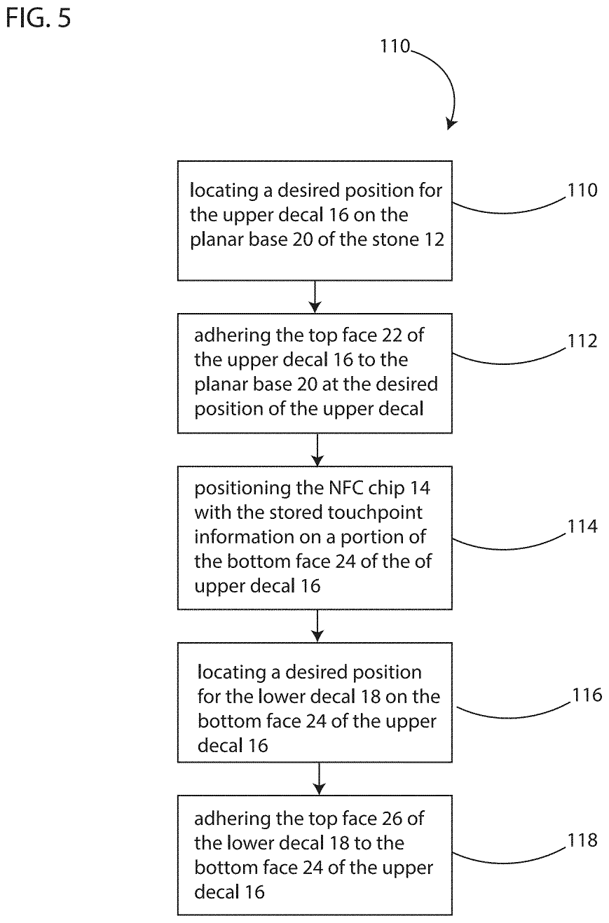

As shown in FIG. 5, the present disclosure generally provides a method 100 for making a merchandising ornament 10 as previously described. The method 100 includes step 110 of locating a desired position for the upper decal 16 on the planar base 20 of the stone. In an embodiment, the desired position is an approximation of a center point of the planar base 20 of the stone 12. Once the desired position is located, step 112 includes adhering the top face 22 of the upper decal 16 to the planar base 20 at the desired position of the upper decal. When the upper decal 16 is substantially same size and general shape as the planar base 20 and placed at the center point of the planar base, the transparent material of the stone 12 may not be visible from a bottom view of the stone. In step 114, the NFC chip 14 with the stored touchpoint information is positioned on a portion of the bottom face 24 of the upper decal 16. Once the NFC chip 14 is placed on the bottom face 24 of the upper decal 16, a desired position (e.g., a center of the bottom face of the upper decal 16 and thereby the center of the planar base 20) for the lower covering 18 is located in step 116. Once located, the top face 26 of lower covering 18 is adhered to the bottom face 24 of the upper decal 16 in step 118.

When introducing elements of the present invention or the one or more embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above apparatuses, systems, and methods without departing from the scope of the invention, it is intended that all matter contained in the above description and shown in the accompanying drawings shall be interpreted as illustrative and not in a limiting sense.

What is claimed is:

1. A merchandising ornament comprising:
a stone being at least semitransparent including a generally planar base;
a near-field communication chip coupled to the stone and configured to store touchpoint information and being configured to transfer the touchpoint information to a receiving device;
an upper decal comprising a top face and a bottom face, the top face bearing a design and being adhered to at least a portion of the planar base of the stone such that the design on the front face is visible through the stone; and
a lower covering comprising a top face and a bottom face, the top face of the lower covering being adhered to the bottom face of the upper decal such that the near-field communication chip is secured and concealed between the upper decal and the lower covering.

2. The merchandising ornament of claim 1, wherein the lower covering is a lower decal, the bottom face of the lower decal bearing a design.

3. The merchandising ornament of claim 2, wherein the design on the bottom face of the lower decal is different than the design on the top face of the upper decal.

4. The merchandising ornament of claim 1, wherein the touchpoint information comprises a url for a business site.

5. The merchandising ornament of claim 1, wherein the design of the top face of the upper decal is associated with the business.

6. The merchandising ornament of claim 1, wherein the upper decal, lower covering, and the planar base all have substantially same size and general shape.

7. A method for making a merchandising ornament of claim 1, the method comprising:
locating a desired position for the upper decal on the planar base of the stone;
adhering the top face of upper decal to the planar base at the desired position of the upper decal;
positioning the near-field communication chip with the stored touchpoint information on a portion of the bottom face of the upper decal;
locating a desired position for the lower covering on the near-field communication chip and the upper decal; and
adhering the top face of lower covering at the desired position of the lower covering.
